(19) United States
(12) Patent Application Publication
(10) Pub. No.: US 2009/0008019 A1
(43) Pub. Date: Jan. 8, 2009

(54) Use of Infrared Thermography as an Agent for Determining the Hardening Course of a Two-Component Composition

(75) Inventors: Manuel Buck, Gebenstorf (CH); Fabio Cirillo, Reinach (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/087,655

(22) PCT Filed: Apr. 3, 2007
(86) PCT No.: PCT/EP2007/053202

§ 371 Date: Jul. 24, 2008

(30) Foreign Application Priority Data
Apr. 3, 2006 (EP) 06112172.9

(51) Int. Cl. B32B 38/00; G01J 5/02; B32B 37/00; B32B 41/00; E06B 3/00; B65H 1/00

(52) U.S. Cl. 156/64; 250/341.6; 156/379.8; 156/350; 156/362; 52/204.5; 414/222.01

(57) ABSTRACT

The invention relates to the use of infrared thermography as an agent for determining the hardening course of a two-component composition. By use of this, mixing errors, in particular, can be detected at an early stage and the infrared thermography can be used as an agent for performing controls during the process for optimizing the dosing ratio of the two-components and for detecting the end of the gel time. Due to this type of use, it is possible to detect errors earlier, that is, prior to joining to or contacting with the surface of the substrate, thus leading to a faster and safer process and to lower rejection or reconditioning costs. The invention also relates to a production line, an industrially produced and to a structure or a transport agent.

### FIELD OF THE INVENTION

The invention pertains to the field of the curing of two-component compositions.

### BACKGROUND ART

Two-component compositions have been in widespread use for a long time. Two-component compositions cure when the two components are mixed. On account of the rapid curing of a multiplicity of two-component compositions they find broad uses in industrial processes. For the curing of two-component compositions, more particularly of adhesives, effective mixing of the two components is very important. Poor mixing, and also metering errors, may have stark consequences for the curing and hence for the mechanical properties of the cured composition. For reliable quality it is therefore very important to ensure the quality of the mixing operation and also the metering accuracy. Mixing errors are attributable to a variety of causes. On the one hand, the quality of mixing is dependent on the consistency of the two components; on the other hand it is very dependent on the mixing equipment used and also on the mixing time. In order to be able to ascertain whether in fact both components are present and how effectively they are mixed with one another, the two components are often colored with two different colors. The colors in this case are typically chosen so that the mixed color is very different from the unmixed colors. Thus, for example, the color combinations white/black, white/red, white/blue or blue/yellow are used for this purpose. The appearance of color differences or color streaks is an indicator, for example, that stirring has not been carried out for long enough or that, in a static mixer, too few mixing elements have been used. This visual method of ascertainment, however, is very insensitive, on the one hand; on the other hand, only a small number of color combinations can be realized using this technique. In the case of seals or visible bonds, of the kind which frequently occur when bonding transparent materials or decorative applications, such limitation on the color of the mixed composition is a great disadvantage. More particularly, colorless or light-colored compositions are either impossible or very difficult to realize in this way.

The open time of a two-component composition is the term for the time which elapses between mixing and the moment at which the composition, owing to the advancement of crosslinking, can no longer be employed for the intended use. In the case of an adhesive or sealant, this moment is the moment at which the composition no longer adheres to a surface contacted with the composition. The open time is therefore a limiting factor in any process in which a two-component composition is employed. In many cases, unfortunately, an exceedance of the open time is not visible and becomes apparent in certain circumstances only in the event of damage. In order to prevent such damage events, bonds and seals, more particularly, are intensively tested after curing. Methods used for such quality testing of adhesive bonds include, more particularly, ultrasound, X-rays, and, more recently, infrared thermography as well. The disadvantage of these methods, however, is that the test takes place only after curing and not prior to assembly. Consequently, if it is found when testing such a composite that the bond or seal exhibits deficiencies, the entire composite must be discarded or, at best, separated—at great cost and complexity, and distributed back into the process. This leads to large losses particularly in the case of expensive or mechanically delicate substrates.

### BRIEF DESCRIPTION OF THE INVENTION

It is the object of the present invention, therefore, to provide a method which overcomes the disadvantages of the prior art and which more particularly makes it possible to determine the cure profile of a two-component composition and more particularly to give reliable information on the quality of mixing and the open time prior to assembly or contacting with a substrate surface.

Surprisingly it has been found that, in accordance with claim 1, infrared thermography constitutes a means of this kind which is capable of achieving this object.

This method is suitable more particularly for industrial manufacture of articles, more particularly for industrially bonded articles. It allows the quality of the mixing of two components to be assessed at an early stage and allows any defects to be identified at an early stage.

Accordingly it is possible in a simple way to determine the cure profile. More particularly it is possible to recognize mixing errors at an early stage and use them as a means of in-process control for the optimization of the metering ratio of the two components and also the recognition of the end of the open time. A use of this kind allows possible errors to be recognized at an early stage, in other words prior to assembly or contacting with a substrate surface, leading to a more rapid and reliable process and also to lower reject or reprocessing costs.

Further subject matter of the present invention, accordingly, comprises a manufacturing line as claimed in claim 12, an industrially manufactured article as claimed in claim 17, and a built structure or means of transport as claimed in claim 19.

Preferred embodiments of the invention are subject matter of the dependent claims.

### EMBODIMENTS OF THE INVENTION

The present invention relates on the one hand to the use of infrared thermography as a means of determining the cure profile of a two-component composition.

The two-component composition used for this purpose is composed of two components, K1 and K2. In principle all two-component compositions are suitable.

In a preferred first version the first component here, K1, comprises at least one compound having at least two functional groups X, and the second component, K2, comprises at least one compound having at least two functional groups Z, the functional group X and the functional group Z reacting chemically with one another, more particularly via an addition reaction.

The functional group X is more particularly selected from the group encompassing NCO, epoxy, (meth)acrylic acid, (meth)acrylate, and alkoxysilane, and the group Z is more particularly selected from the group encompassing NH₂, NH, SH, and OH.

In one preferred embodiment the first component K1 comprises at least one polyisocyanate or at least one isocyanate-group-terminated polyurethane prepolymer, and the second component K2 comprises at least one polyol or a polyamine. Compositions of this kind are also known to the skilled worker as two-component polyurethane compositions.

The prefix “poly” in designations for substances, such as “polyol”, “polyamine”, “polyglycidyl ether”, “polymercaptan” or “polyisocyanate”, indicates in the present document that the substance in question contains, formally, more than one of the functional group occurring in its designation, per molecule.

In a further preferred embodiment the first component K1 comprises at least one polyisocyanate or at least one isocyanate-group-terminated polyurethane prepolymer, and the second component K2 comprises at least water.

In a further preferred embodiment the first component K1 comprises at least one polyglycidyl ether and the second component K2 comprises at least one polyamine or a polymercaptan. Polyglycidyl ethers preferred for this purpose are diglycidyl ethers of bisphenol A and bisphenol F and also mixtures thereof. Compositions of this kind are also known to the skilled worker as two-component epoxy resin compositions.

In a preferred second version the first component K1 comprises at least one compound which polymerizes under the influence of a catalyst or an initiator which is present in the second component K2.

In one preferred embodiment of this version the compound that polymerizes under the influence of a catalyst or initiator of component K2 is an unsaturated compound which is selected from the group consisting of styrene, acrylonitrile, (meth)acrylamides, (meth)acrylic acid, (meth)acrylates, vinyl alcohols, vinyl ethers, vinyl esters, and unsaturated polyesters, and is preferably a (meth)acrylate. The second component K2 of this embodiment comprises as initiator a free-radical initiator, more particularly a peroxide or hydroperoxide or a perester, preferably an organic peroxide.

In certain cases, when, for example, the second component comprises a catalyst or an initiator, the open time can be adjusted within a certain range, i.e., optimized for the bonding operation, by varying the ratio of K1 to K2. The range within which the pot life can be varied, without unduly detracting from the mechanical properties of the cured composition, is very heavily dependent on the two-component composition in question.

Components K1 to K2 may also include further constituents of the kind known to the skilled worker for two-component compositions. Further constituents of this kind are more particularly additives such as plasticizers, fillers, adhesion promoters, UV absorbers, UV stabilizers and/or heat stabilizers, antioxidants, flame retardants, optical brighteners, catalysts, color pigments or dyes. Particularly preferred such further constituents are fillers. Preferred fillers are carbon black and chalks, both coated and uncoated.

Thixotropic agents are, more particularly, fumed silicas or urea derivatives of the kind disclosed in EP-A-1 152 019, for example.

It is preferred for the composition, and/or components K1 and K2, to have a pasty consistency. This is achieved in particular through the use of fillers and/or thixotropic agents as additional constituents. The reason is that, particularly in the case of pasty compositions, problems occur with the quality of mixing, and so the here-described use of thermography as a means of determining the cure behavior is very advantageous for these compositions in particular.

Infrared thermography is used as a means of determining the cure profile of an afore-described two-component composition.

This method can be used to determine on the one hand the open time and on the other hand the quality of mixing.

Since the curing of a two-component composition is an exothermic process, the heat given off on curing can be detected and evaluated by means of IR thermography, more particularly via an infrared camera. Since this IR thermography preferably displays a thermal picture of a surface, the cure profile can be determined from the spatial and temporal detection of heat.

When the thermal distribution over the surface of a mixed two-component composition is homogeneous, the quality of mixing is good, whereas the appearance of “hot spots” is caused by poor mixing. Consequently, from monitoring and comparing the local and temporal changes in heat, it is possible to determine the quality of mixing.

Since the crosslinking reaction produces heat, it can be used to determine the end of the open time via the temperature development. To start with the composition possesses the initial temperature T₀. After the mixing of the two components, there is a latency time tₓ within which substantially no increase in temperature can be detected. At the beginning of crosslinking there is a small amount of heat given off by the composition, which becomes ever greater as crosslinking progresses, up to a maximum temperature Tₘₐₓ. After the end of the reaction, the composition slowly cools down again. As a result of the dissipation of heat, however, when the heat maximum Tₘₐₓ is reached, the open time has already been exceeded. The particular measured temperature that describes the end of the open time (tₒₜ), however, is heavily dependent on the individual two-component composition. This temperature is dependent on factors including the chemical reactivity, the ambient temperature, and the chemistry of the two-component composition. This temperature can, however, be determined by correlation with a physical test method, of the consistency, the tack and/or the viscosity, for example.

Accordingly, by monitoring the temperatures over the entire surface under observation for a composition, it is possible to determine an exceedance of the open time when cooling is ascertained after the attainment of the maximum temperature.

For the infrared thermography it is preferred to use an infrared camera. This IR camera is preferably linked to a computer. The computer is preferably running a computer program which analyzes the thermal picture information transmitted to the computer by the camera, and, according to pre-set threshold levels, emits an alarm or a signal to an adhesive metering unit and/or to a removal station.

Apparatus suitable more particularly for IR thermography includes those capable of detecting temperatures in the range between −20° C. and 200° C., more particularly between 0° C. and 150° C. Apparatus which has shown itself to be very advantageous comprises those capable of operating over a relatively long time period with a high temporal resolution. Depending on the reactivity of the composition, observation periods of up to several hours, typically of up to 20 minutes, with a frequency of up to 30 images per second are required. As well as a high spatial resolution, a high temperature sensitivity is a further great advantage. An IR camera which has proven particularly suitable for this purpose is the MIDAS 320 thermal imaging camera from DIAS Infrared GmbH, Germany.

Infrared thermography as a means of determining the cure behavior can be used in principle for any application of an above-described two-component composition. More particularly it is suitable for applications of the two-component composition as floor coverings, paints, coatings, sealants or adhesives. Particular preference, however, is given to their application as adhesives. More particularly preferred is a method of producing an industrially bonded article wherein, for the bonding operation, infrared thermography, in accordance with a use as described above, is used as a means of determining the cure profile.

From the determination of the cure profile it is possible to optimize the process time of a bond. Rapid manufacturing processes prefer fast adhesives. In the case of large-area or extensive complex bonds, however, the open time of the adhesive is frequently a critical factor. Through knowledge and control of the open time it is possible to optimize the process time in such a way that assembly takes place within the open time, and therefore a reliable bond is ensured. In this way, on the one hand, the open time of the adhesive can be adapted to the predetermined cycle times of a manufacturing operation, or else the cycle time can be adapted to the open time of an adhesive.

The method of adhesive bonding encompasses the following steps
applying an adhesive whose first component K1 and second component K2 have been mixed with one another by means of mixers to a surface of a substrate S1
monitoring the cure profile by means of thermography
contacting the adhesive with the surface of a further substrate S2 before the end of the open time

After contacting has taken place, the crosslinking of the adhesive progresses, and a bonded article is formed.

The nature of the substrates S1 and S2 may be very different. They may be alike or different from one another. Preferred substrates are plastics, more particularly thermoplastics, glasses, ceramics, metals and their alloys, materials of construction that are based on natural materials, such as wood, chipboard, and also coating materials. The most preferred substrates are painted substrates, such as painted metal flanges, plastics, more particularly PVC, and also glass, more particularly ceramic-coated glass.

The two components may be mixed via static or dynamic mixers. Using a dynamic mixer has the advantage that the mixing intensity can be varied in a simple way prompted, for example, as described later on below, via a signal from a thermography station. The adhesive is typically applied in the form of a bead of adhesive, preferably a triangular bead.

The conveying and the appropriately corrected metering of the two components of the adhesive may be via a 2-component cartridge gun, which may be operated manually, hydraulically or pneumatically; via a 2-component piston pump/meterer; via a 2-component gear pump/meterer.

Hence an industrially bonded article produced by a method as described above also forms a further aspect of the present invention.

This article is more particularly a door or a window or a means of transport or a module for installation on or in a means of transport. Preferably it constitutes an automobile whose glazing, for example, has been produced by the method described.

With further preference this article is a window or a door. In the case of large-area windows or doors in particular, the applied beads of adhesive are long. Owing to this length, a considerable time elapses between the start point and end point of the adhesive bead. After the adhesive has been applied, however, there must still be sufficient time for assembly. It is therefore critical in particular in these large-area adhesive applications if the open time is exceeded at certain sites in the adhesive bead. An exceedance of the open time has the effect that, at these sites, the adhesive bond is not ensured and hence at these sites there are weak points in force transmission and/or sealing.

The industrially bonded articles described can be stored and transported. On account of the trend for manufacturing away from the line and into the supplier plant, the use of exterior and interior modules which are produced at a location other than that of final manufacture is becoming more and more important.

Within the construction sector, industrially manufactured exterior and interior modules have been used for many years.

Accordingly a built structure or means of transport which comprises an industrially bonded article as described above forms a further aspect of the invention.

Since the use of infrared thermography as a means of determining the cure behavior is preferential in particular for industrial manufacture of articles, a manufacturing line for the production of an article forms a further aspect of the present invention.

Said manufacturing line features, in the downstream direction,
a) at least one application station for a two-component adhesive K which is mixed via a mixer and is composed of a first component K1 and a second component K2,
b) at least one thermography station, and
c) at least one assembly station.

“In the downstream direction” means in this context “temporally successively sequential in the manufacturing operation”. In order to ensure efficient output in the sense of an industrial manufacturing line, it is clear that the manufacturing line is charged not only with one article in each case, but instead that, at a given point in time, articles at different stages of manufacture are present at each of the stations.

Manufacture is preferably automatic, although this is not to rule out the presence of certain manual stations, or that interventions by human beings may be performed.

In one embodiment there is a communication link between the thermography station and the adhesive application station. More particularly it is possible via this communication link to transmit a signal on the basis of which the ratio of the metering of the amount of the first component K1 to the second component K2 in the adhesive application station can be changed.

In a further embodiment of the manufacturing line there is a removal station disposed between thermography station and assembly station, and there is a communication link between thermography station and removal station. More particularly this communication link transmits a signal on the basis of which a semifinished product which has traversed the manufacturing line up to the removal station is removed from the manufacturing line.

In a further embodiment of the manufacturing line there is a removal station disposed between thermography station and assembly station and there is a communication link between thermography station and removal station and between the thermography station and the adhesive application station. Via these communication links it is possible to transmit signals on the basis of which the ratio of the metering of the amount of the first component K1 to the second component K2 in the adhesive application station can be changed, and/or on the basis of which a semifinished product which has traversed the manufacturing line up to the removal station is removed from the manufacturing line.

### BRIEF DESCRIPTION OF THE DRAWINGS

In the text below, on the basis of the drawings, selected working examples of the invention are elucidated in more detail. Like elements are given the same reference symbols in the different figures. The direction of forces and/or movements is indicated using arrows.

FIG. 1 shows a schematic drawing of a manufacturing line

FIG. 2 shows a schematic drawing of a manufacturing line with optimization of the metering ratio

FIG. 3 shows a schematic drawing of a manufacturing line with a removal station

FIG. 4 shows a schematic drawing of a manufacturing line with optimization of the metering ratio and a removal station

FIG. 5 shows a schematic cross section through a manufacturing line with optimization of the metering ratio

FIG. 6 shows a schematic cross section through a manufacturing line with removal station

FIG. 7 shows thermal images of a pneumatic application of a methacrylate adhesive at 10° C. after various times after application

FIG. 8 shows a graph of the temperature profile of two selected points in the adhesive bead (points 3 and 4) in FIG. 7

FIG. 9 shows thermal images of a manual application of a methacrylate adhesive at 10° C. after various times after application

FIG. 10 shows a graph of the temperature profile of two selected points in the adhesive bead (points 3 and 4) in FIG. 9

FIG. 11 shows a three-dimensional depiction of the temperature profile along line 1 (pneumatic application) (back) and along line 2 (manual application) (front) on adhesive beads after various times t_{obs} after application.

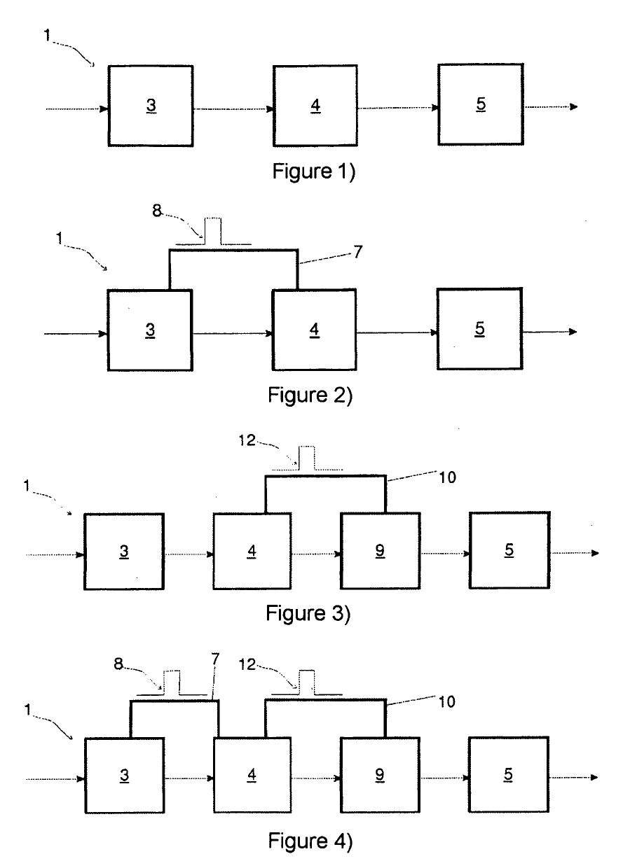

FIG. 1 shows diagrammatically a manufacturing line 1 for the production of an article 2. This manufacturing line features sequentially in the downstream direction the following stations:

a) at least one adhesive application station 3,

b) at least one thermography station 4, and

c) at least one assembly station 5

In the adhesive application station 3 the two-component adhesive K mixed via a mixer 6, and composed of a first component K1 and a second component K2, is applied.

Described in FIG. 2 is a preferred embodiment of the manufacturing line 1 described in FIG. 1 for the production of an article 2, namely a manufacturing line with optimization of the metering ratio. In this case there is a communication link 7 between thermography station 4 and adhesive application station 3. This communication link 7 transmits a signal 8 from the thermography station to the adhesive application station 3, on the basis of which signal the ratio of the metering of the amount of the first component K1 to the second component K2 can be changed.

FIG. 3 describes a further preferred embodiment of the manufacturing line 1 described in FIG. 1 for the production of an article 2, namely a manufacturing line with a removal station 9 disposed between thermography station 4 and assembly station 5. In this case there is a communication link 10 between thermography station 4 and removal station 9. This communication link 10 transmits a signal 12 from the thermography station to the removal station 9, on the basis of which signal the removal is initiated of a semifinished product 11 which has traversed the manufacturing line up to the removal station.

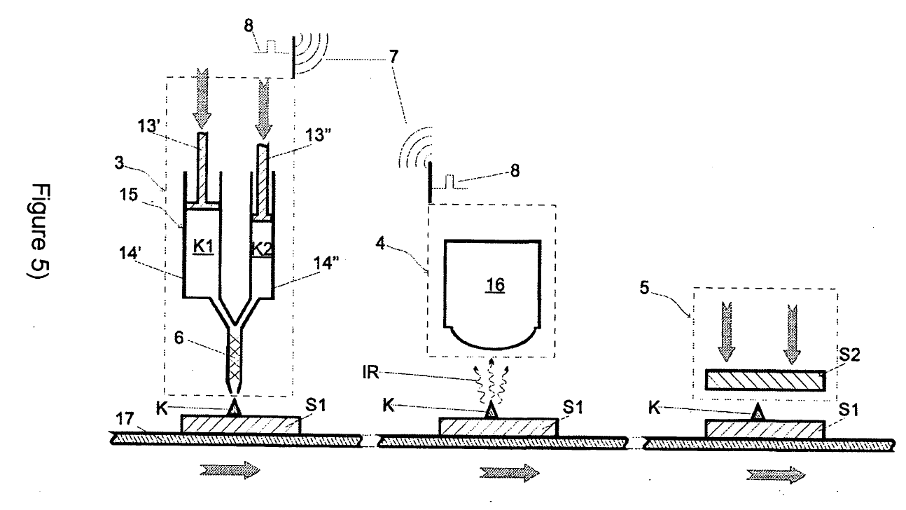

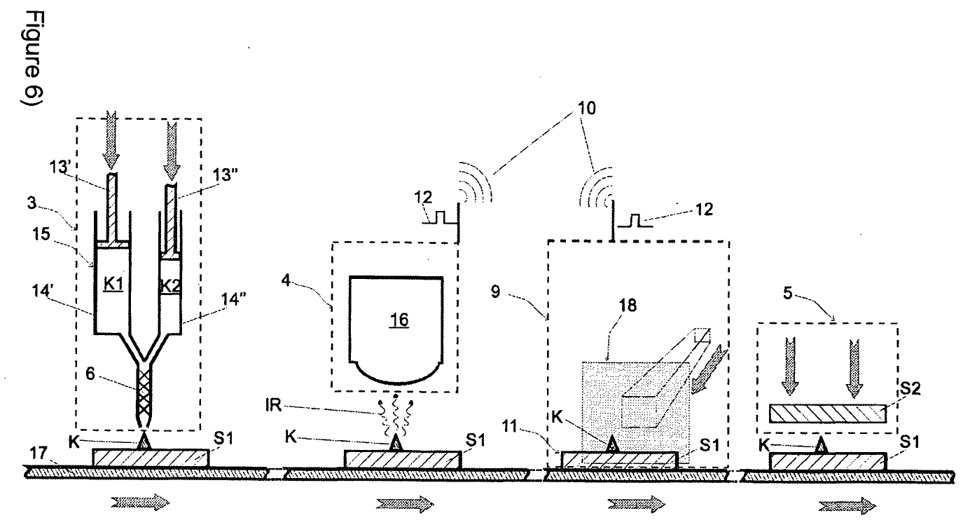

FIG. 4 depicts a further preferred embodiment of a manufacturing line 1, which essentially constitutes a combination of the embodiments described above for FIGS. 2 and 3; in other words, there is a communication link 7 between thermography station 4 and adhesive application station 3 and there is a communication link 10 between thermography station 4 and removal station 9. In this variant embodiment not only the ratio of the metering of the amount of the first component K1 to the second component K2 can be optimized by a signal 8 transmitted from the thermography station 4 via the communication link 7 to the adhesive application station 3, but also a signal 12 transmitted from the thermography station 4 via the communication link 10 to the removal station 9 prompts removal of a semifinished product 11 from the manufacturing line 1.

FIG. 5 shows a schematic cross section through a manufacturing line for the manufacture of an article 2 with optimization of the metering ratio. The manufacturing line 1 depicted here has a conveyor belt 17, on which a substrate S1 is moved first to an adhesive application station 3, subsequently to a thermography station 4, and finally to an assembly station 5. At the adhesive application station 3 the adhesive K, mixed from components K1 and K2 via a mixer 6, is applied to the surface of the substrate S1, in the form more particularly of a triangular bead. In the embodiment depicted here the first component K1, and the second component K2, are metered each by means of a metering piston 13′ and 13″, respectively, from a cartridge cylinder 14′ and 14″, respectively. It is clear to the skilled worker that instead of the version shown here of a dual cartridge 15 it is also possible to use other conveying and/or metering devices, such as conveying/metering by piston press via follower plate from hobbocks or drums, for example. The movement of the metering pistons 13′ and 13″ is preferably separate from one another, allowing the metering ratios and metering amounts to be optimized.

In a further station in the production process of an article, the heat, i.e., the IR radiation, that is developed on account of the ongoing crosslinking of the adhesive K is detected and analyzed in the thermography station 4. In the depiction shown here there is an IR camera 16 in the thermography station. Analysis is performed in a computer (not shown). If mixing errors or metering errors are discovered, the computer initiates a signal 8 which is transmitted via a communication link 7 to the adhesive application station 3. In the form depicted here, the communication link 7 is a radio link. The communication link 7 may also, however, be a cable. The communication link 7 may be either unilateral or bilateral. The signal 8 allows the mode of movement and/or distance of movement of the metering pistons 13′ and 13″ respectively to be controlled and thereby optimized. It is clear that when there is a severe mixing error it is possible, as a result of a further signal, to trigger manual or automatic removal of the semifinished product when, for example, as shown in FIG. 3 or in FIG. 6, a removal station 9 is part of the manufacturing line.

In a further station in the production process of an article, the semifinished product, i.e., the substrate S1 with the adhesive K applied thereto, is assembled with a further substrate, S2, in an assembly station 5. Assembly is followed by ultimate crosslinking to give a bonded article 2.

FIG. 6 shows a schematic cross section through a manufacturing line for the manufacture of an article 2 with a removal station 9.

The manufacturing line 1 depicted here has a conveyor belt 17, on which a substrate S1 is moved first to an adhesive application station 3, subsequently to a thermography station 4, then to a removal station 9, and finally to an assembly station 5. At the adhesive application station 3 the adhesive K, mixed from components K1 and K2 via a mixer 6, is applied to the surface of the substrate S1, in the form more particularly of a triangular bead. In the embodiment depicted here the first component K1, and the second component K2, are metered each by means of a metering piston 13′ and 13″, respectively, from a cartridge cylinder 14′ and 14″, respectively. It is clear to the skilled worker that instead of the version shown here of a dual cartridge 15 it is also possible to use other conveying and/or metering devices, such as conveying/metering by piston press via follower plate from hobbocks or drums, for example. The movement of the metering pistons 13′ and 13″ is preferably separate from one another, allowing the metering ratios and metering amounts to be optimized.

In a further station in the production process of an article, the heat, i.e., the IR radiation, that is developed on account of the ongoing crosslinking of the adhesive K is detected and analyzed in the thermography station 4. In the depiction shown here there is an IR camera 16 in the thermography station. Analysis is performed in a computer (not shown). If exceedance of the open time is detected, the computer initiates a signal 12 which is transmitted via a communication link 10 to the removal station 9. In the form depicted here, the communication link 10 is a radio link. The communication link 10 may also, however, be a cable. The communication link 10 may be either unilateral or bilateral.

In a further station in the production process of an article, the semifinished product 11 arrives at the removal station 9. Where appropriate, when the open time is exceeded, this removal station, on the basis of a signal 12 transmitted via the communication link 10, removes from the manufacturing line the semifinished product which has traversed the manufacturing line up to the removal station. For the purpose of removal, this removal station 9 possesses removal means 18. Said removal means 18 may take different forms. They may be, for example, a robot gripper arm or, as shown in FIG. 6, a pusher 16, which removes the semifinished product from the manufacturing line 1 by means of a movement transverse to the running direction of the conveyor belt 17.

If the open time is not exceeded, and hence the removal means 18 are not activated, the semifinished product remains in the manufacturing line and passes to a further station, the assembly station 5. There the semifinished product, i.e., the substrate S1 with the adhesive K applied thereto, is assembled with a further substrate, S2. Assembly is followed by ultimate crosslinking to give a bonded article 2.

### EXAMPLES

A two-component adhesive was prepared that has the ingredients described in table 1. Components K1 and K2 were each dispensed into one cartridge cylinder of a 200 ml twin cartridge (10:1, Mixpac, Switzerland), or into two hobbocks, respectively.

TABLE 1
Adhesive

| | Parts by weight |
|---|---|
| Component K1 | |
| tetrahydrofurfuryl methacrylate | 42 |
| Hycar VTBNX 1300 X33 | 21 |
| Paraloid EXL 2600 | 16 |
| p-toluidine | 1 |
| chalk | 20 |
| Component K2 | |
| benzoyl peroxide paste (45% in | 25 |
| plasticizer) | |
| chalk | 25 |
| extender | 35 |
| organic thixotropic agent | 14 |
| black pigment | 1 |

### Experimental Setup

The following experiments took place in a climatically controlled cabinet adjusted to the respective temperature. The adhesive mixed by static mixer was applied as a bead of adhesive to a rubber mat as insulation layer, with a bead length of approximately 30 cm. A MIDAS 320 infrared camera from DIAS Infrared GmbH, Germany, was fixed on a stand at a distance of around 50 cm from the adhesive beads, connected to a laptop and controlled by means of the Midas Spec R/T computer program. The cure profile was monitored via recording of thermal images at one image per second. By virtue of the fact that, during recording, application can be recognized in the image sequence, it is possible, for a particular observed point, to determine the moment t=0, i.e., the point of application.

### Cure Behavior

In a first experiment the quality of mixing of pneumatic and manual application of the adhesive in a mixing ratio K1:K2 of 10:1 at 10° C. was monitored.

The simultaneous ejection of the two cylinders of the cartridge is accomplished either by a trigger, actuated by muscle power in the case of the manual gun, or by a pneumatically (compressed air, 2.5 bar) actuated cylinder in the case of the pneumatic gun. In the case of the manual version the pressing and release of the trigger generates an “intake of air” by the cartridge.

The two beads of adhesive were applied simultaneously alongside one another. The whole bead was applied within 10 seconds.

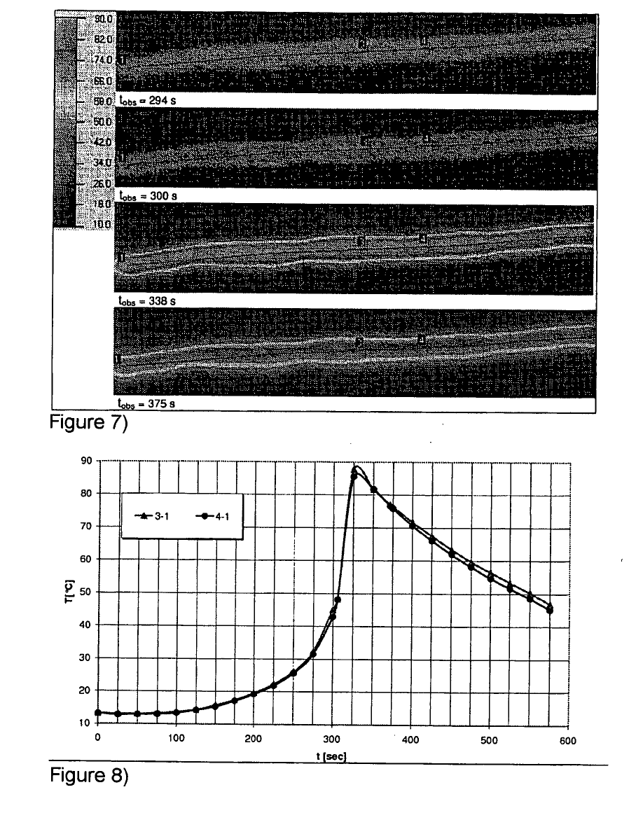

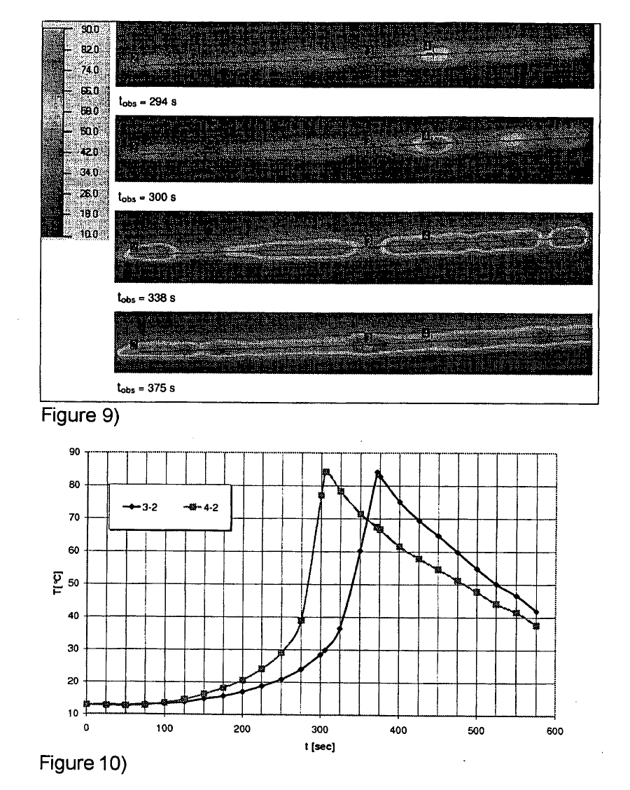

FIG. 7 and FIG. 9 (adhesive application from right to left) respectively show the thermal images for the bead with pneumatic application (line “1” in FIG. 7) and for the bead with manual application (line “2” in FIG. 9), at a time (“t_{obs}”) after the application of adhesive (measured at point 4) of 294 s, 300 s, 338 s, and 375 s. FIGS. 8 and 10 show the course of the temperature over time, as measured at points identified by “3” and “4” in the respective bead (line “3” and “4”, respectively).

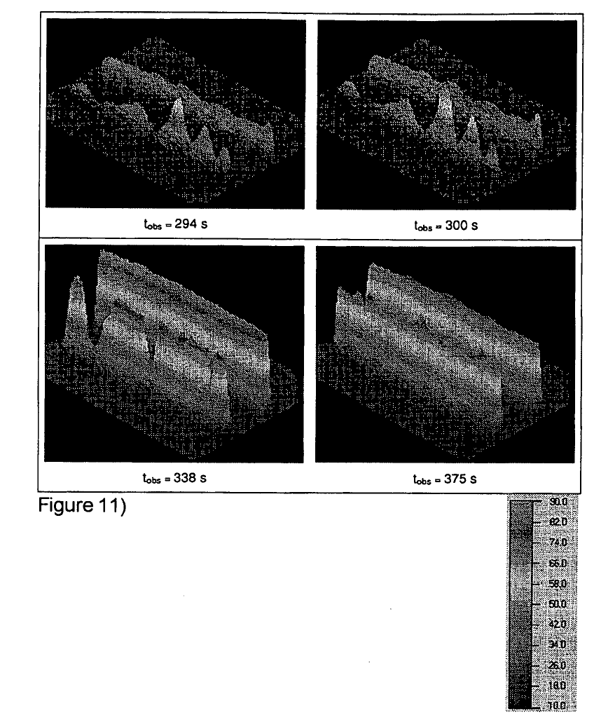

FIG. 11, finally, shows a three-dimensional representation of the heat distribution along the lines “1” and “2” as entered in FIGS. 7 and 9 on the adhesive bead.

In all of the thermal images the temperature measured (° C.) has been shown by means of a color corresponding to the color coding indicated.

From FIGS. 7 to 11 it is apparent that, in comparison between the pneumatic and the manual application, the cure behavior in manual application is much more heterogeneous. Within the bead there are sharp temperature fluctuations. For the end of the open time a temperature of about 25° C. has been determined. Consequently, in the case of manual application, there are locations at which these temperatures are exceeded after just 250 seconds (point 4), whereas in the case of pneumatic application this limit is only exceeded at 266 seconds (points 3 and 4). The difference in time at which the same temperature (T>25° C.) is reached at points 3 and 4 in the case of manual application is approximately 55 seconds, whereas in the case of pneumatic application it is only 1 to 2 seconds.

### Varying the Mixing Ratio

By varying the ratio of component K1 to component K2 it was possible to vary the adhesive's open time. The metering ratio was set using a unit from the company Failsafemetering, UK, to the different metering ratios. The pulse meter system from Failsafemetering allows this setting to be made, by limiting the travel of the metering pistons. The material pressures set for the scoop piston supply pumps from respective hobbocks were 30 bar for the first component K1 and 50 bar for the second component K2. In this experiment the adhesive was applied at 20° C. as described above with the pneumatic metering using a variable mixing ratio. The end of the open time determined was the temperature of around 30° C. Curing was monitored by means of infrared camera. The thermal images showed a homogeneous distribution of heat within the beads.

TABLE 2
Open time as a function of mixing ratio

| Ratio K1/K2 | 6/1 | 8/1 | 10/1 | 13/1 |
|---|---|---|---|---|
| Open time [s] | 76 | 77 | 82 | 90 |

### LIST OF REFERENCE SYMBOLS

1 Manufacturing line
2 Article
3 Adhesive application station
4 Thermography station
5 Assembly station
6 Mixer
7, 10 Communication link
8, 12 Signal
9 Removal station
11 Semifinished product
13′, 13′ Metering pistons
14′, 14″ Cartridge cylinders
15 Twin cartridge
16 Infrared camera
17 Conveyor belt
18 Removal means, pusher
IR Infrared radiation
K Mixed two-component composition
K1 First component
K2 Second component
S1 First substrate
S2 Second substrate

1. A method of determining the cure profile of a two-component composition, comprising determining the cure profile using infrared thermography.

2. The method as claimed in claim 1, wherein the two-component composition is composed of a first component K1 and a second component K2,
the first component K1 comprising at least one compound having at least two functional groups X,
and the second component K2 comprising at least one compound having at least two functional groups Z,
and the functional group X and the functional group Z reacting chemically with one another, more particularly via an addition reaction.

3. The method as claimed in claim 2, wherein the first component K1 comprises at least one polyisocyanate or at least one isocyanate-group-terminated polyurethane prepolymer,
and the second component K2 comprises at least one polyol or a polyamine.

4. The method as claimed in claim 2, wherein the first component K1 comprises at least one polyglycidyl ether,
and the second component K2 comprises at least one polyamine or a polymercaptan.

5. The method as claimed in claim 1, wherein the two-component composition is composed of a first component K1 and a second component K2,
the first component K1 comprising at least one compound which polymerizes under the influence of a catalyst or initiator which is present in the second component K2.

6. The method as claimed in claim 5, wherein the first component K1 comprises an unsaturated compound, more particularly an unsaturated compound selected from the group consisting of styrene, acrylonitrile, (meth)acrylamides, (meth)acrylic acid, (meth)acrylates, vinyl alcohols, vinyl ethers, vinyl esters, and unsaturated polyesters, preferably a (meth)acrylate;
and the second component K2 comprises a peroxide or hydroperoxide or a perester, preferably an organic peroxide.

7. The method as claimed in claim 1, comprising using an infrared camera to detect infrared radiation.

8. The method as claimed in claim 1, further comprising determining an open time of the two-component composition from the determined cure profile.

9. The method as claimed in claim 2, wherein a metering ratio of the first components K1 and the second components K2 is optimized from the determined cure profile.

10. A method of producing an industrially bonded article, wherein for the bonding operation infrared thermography in accordance with claim 1 is used to determine the cure profile.

11. The method as claimed in claim 10, wherein a process time of a bond is optimized from the determined cure profile.

12. A manufacturing line for the production of an article, comprising sequentially in the downstream direction
a) at least one application station for a two-component adhesive K which is mixed via a mixer and is composed of a first component K1 and a second component K2,
b) at least one thermography station, and
c) at least one assembly station.

13. The manufacturing line as claimed in claim 12, wherein between thermography station and adhesive application station there is a communication link.

14. The manufacturing line as claimed in claim 13, wherein on the basis of a signal which is transmitted via the communication link the ratio of the metering of the amount of the first component K1 to the second component K2 is changed.

15. The manufacturing line as claimed in claim 12, wherein disposed between thermography station and assembly station there is a removal station, and between thermography station and removal station there is a communication link.

16. The manufacturing line as claimed in claim 15, wherein the removal station removes a semifinished product which has traversed the manufacturing line up to the removal station from the manufacturing line on the basis of a signal transmitted via the communication link.

17. An industrially bonded article produced by the method as claimed in claim 10.

18. The industrially bonded article as claimed in claim 17, wherein the article is a door or a window or a means of transport or a module for installation on or in a means of transport.

19. A built structure or means of transport comprising an industrially bonded article as claimed in claim 17.
